(19) United States
(12) Patent Application Publication
(10) Pub. No.: US 2026/0149865 A1
(43) Pub. Date: May 28, 2026

(54) SYSTEMS AND METHODS FOR VEHICLE INFORMATION CAPTURE USING WHITE LIGHT

(71) Applicant: Leonardo US Cyber and Security Solutions, LLC, Greensboro, NC (US)

(72) Inventor: Dennis Bernardo D'Annunzio, Greensboro, NC (US)

(21) Appl. No.: 19/401,468

(22) Filed: Nov. 26, 2025

Related U.S. Application Data
(63) Continuation of application No. 17/690,138, filed on Mar. 9, 2022, now Pat. No. 12,513,385.
(60) Provisional application No. 63/158,949, filed on Mar. 10, 2021.

(51) Int. Cl. H04N 23/56; G06T 1/60; G06T 7/20; G06T 7/70; G06V 20/62; H04N 23/51

(52) U.S. Cl. CPC H04N 23/56; G06T 1/60; G06T 7/20; G06T 7/70; G06V 20/625; H04N 23/51; G06T 2207/10024; G06T 2207/10048; G06T 2207/30241; G06T 2207/30256

(57) ABSTRACT

A method for capturing vehicle information utilizing white light illumination, the method comprising the steps of: capturing, from a camera by a computing device, two or more near-infrared (NIR) or infrared (IR) images of a license plate of a vehicle; determining, by the computing device, whether the license plate was captured; in response to a determination that the vehicle's license plate was captured, determining if two or more images containing contiguous images of the vehicle's license plate were captured; in response to a determination that two or more images containing contiguous images of the vehicle's license plate were captured, determining, by the computing device, a target illumination zone and a time that the vehicle will pass through the target illumination zone; determining whether the vehicle is in the target illumination zone; in response to a determination that the vehicle is in the target illumination zone, initiating a pulse, by the computing device, of a white light; capturing, from the camera by the computing device during the pulse, a white light image; and determining, by the computing device, a license plate number based on the white light image.

### CROSS-REFERENCE TO RELATED APPLICATION

The present application is a continuation of U.S. patent application Ser. No. 17/690,138, filed Mar. 9, 2022, which claims benefit of U.S. Provisional Ser. No. 63/158,949 , filed Mar. 10, 2021.

### INCORPORATED BY REFERENCE

The disclosure of U.S. patent application Ser. No. 17/690,138, filed Mar. 9, 2022 and U.S. Provisional Ser. No. 63/158,949 , filed Mar. 10, 2021, are incorporated by reference herein for all purposed as if set in their entireties.

### TECHNICAL FIELD

In one aspect, the present disclosure is directed to systems and methods for capture of a vehicle license plate, and more specifically, to systems and methods for capture and reading of license plate information such as a plate number, among other vehicle information or data. Other aspects also are described.

### BACKGROUND

Automated License Plate Reading (“ALPR”) systems or license plate reading (“LPR”) systems are used for identifying vehicles such as for detecting stolen vehicles, traffic violations, and for collecting tolls, among other various reasons.

Many ALPR or LPR systems utilize a flood light approach to illuminate and capture license plate numbers over one or more lanes, e.g., for full lane coverage. To prevent distraction or unsafe conditions for drivers, ALPR systems generally utilize near infrared (NIR) or infrared (IR) light to read a license plate, e.g., a broad flood of NIR or IR light is generated and reflected images of license plates illuminated thereby are captured by a camera. NIR is barely visible to the eye, while IR is not visible to the eye, which thus helps avoid distraction of drivers, while continuously or frequently capturing NIR or IR imaged plates. However, the use of NIR or IR is dependent upon reflective license plates. Further, even if such ALPR systems are able to read the license plate number, the captured images using IR or NIR are generally monochromatic, making it difficult for current ALPR systems to distinguish other characteristics of the plate and/or vehicle, such as a state or country of origin of a plate, make and model of a vehicle, or color of a vehicle. Finally, if a license plate is not reflective or if a license place is altered in some way to reduce reflectivity, the license plate may not be read by more conventional ALPR systems.

Accordingly, the present disclosure is directed to embodiments of systems and methods for detecting, capturing and reading license plate and/or vehicle information that address the foregoing and other related, and unrelated, problems in the relevant art.

### SUMMARY

Briefly described, the present disclosure includes systems and methods for capture and reading a license plate and/or gathering other information from a vehicle utilizing NIR or IR generated images and targeted white light. A series of NIR or IR images can be captured or collected, and will be utilized to determine a target illumination zone or a location where a target, such as a license plate or other identifying portions or attributes (by way of example and not limitation, bumper stickers, signage or lettering, accessories, decals or other images or customized features, etc.) of a vehicle or is estimated to be at a particular time. For example, two or more NIR or IR generated images can be captured by a camera, an input or otherwise provided to a processor/computing device that will execute programming instructions to determine a projected trajectory of the vehicle and a projected rate/speed of the vehicle, or other factors to enable a determination of a target illumination zone through which the vehicle is projected to travel, and/or during which the target plate/vehicle is or is estimated to be at a determined time. A targeted pulse or beam of white light will be generated and directed toward the target illumination zone, to develop a white light image.

The white light image will be captured by targeting white light at that specific location for a brief period of time by a white light illuminator. Since the NIR or IR images are used to determine the target illumination zone and since the white light image may be captured in a brief amount of time with a single pulse of white light, drivers in corresponding vehicles may not be distracted or even notice the white light pulse. Using the white light image, the LPR system may read the license plate number, determine the state or country of origin of the license plate, and/or determine the make, model, and/or color of the vehicle.

Accordingly, an embodiment of the disclosure is directed to a method for capturing vehicle information utilizing white light illumination. In embodiments, the method may include a computer implemented method for capturing vehicle information wherein at least one computing device performs a series of functions comprising capturing two or more near-infrared (NIR) or infrared (IR) images of a license plate of a vehicle. The image may be captured by an image capture device, a camera, or image sensors. The method may include determining, by the computing device, whether the license plate was captured. The method may include, in response to a determination that the vehicle's license plate was captured, determining, by the computing device, if two or more images containing contiguous images of the vehicle's license plate were captured.

In embodiments, the method may include providing the two or more captured NIR or IR images to a computing device. The method also may include determining, by the computing device, a projected trajectory of travel of the vehicle, and, in some embodiments, based on, or in view of such a projected trajectory, determine a target illumination zone through which the vehicle is projected to travel. The method may further include capturing, a white light image of at least a portion of the vehicle illuminated by the white light pulse, e.g. the white light pulse can illuminate the plate or vehicle in a similar manner to a flash for taking a photograph, or can strike and/or cause an image of the vehicle and/or license plate to be able to be captured by with an image capture device. The white light pulse can be generated with an array of one or more RGB or white light emitting diodes (LEDs), and directed through a lens configured to focus white light produced by the array of RGB or white LEDs at the vehicle so as to strike the vehicle at a location to avoid distraction of a driver of the vehicle The method may finally include determining, by the computing device, a license plate number and at least one additional feature of the vehicle based on the white light image.

In addition, the method may further include, prior to initiation of the pulse of the white light, determining whether the vehicle is in the target illumination zone. The pulse of white light may be initiated based on the determination that the vehicle is in the target illumination zone. In addition, in some aspects, the image capture device may include near-infrared image sensors and red, green, blue (RGB) image sensors. The image capture device may include RGB-NIR image sensors.

In other aspects, the target illumination zone may be defined by a portion of a lane of a one or more lane road. One or more target illumination zones may be defined for different portions of different lanes. The portion of the lane of the one or more lane road may be determined, by the computing device, based on the two or more NIR or IR images. The determination of the portion or the lane of the one or more lane road may further be based on a location of the vehicle at a first time and a location of the vehicle at a second time. In such aspects, the computing device may determine the trajectory of the vehicle based on the slope and intercept of the path of the vehicle. The slope and intercept may be based on the location of the vehicle at the first time and the location of the vehicle at the second time.

In other aspects, the pulse of white light may be produced by a light emitting diode (LED) array disposed behind a lens. The LED array can include red green blue (RGB) LEDs, or white light LEDs. The pulse of white light may be generated by one or more LEDs of the LED array. The one or more LEDs to use during the pulse may be determined based on the target illumination zone or the location of the target illumination zone. Each of the one or more LEDs may correspond to a target illumination zone. Each target illumination zone for each LED or combination of LED may be determined prior to capturing NIR or IR images. Such a pulse of the white light may be of a sufficient time interval and of a sufficient intensity to allow the image capture device to capture the white light image. Further, such a time interval or time frame, and the intensity thereof may be values such that a driver of the vehicle will not see or notice the pulse.

In other aspects, the at least one additional feature of the vehicle may include a state or country of origin for the license plate. The at least one additional feature of the vehicle may also include a vehicle's make, model, or color.

In other aspects, NIR or IR images, white light images, coordinates of a vehicle, velocity of a vehicle, target illumination zones, predictions (e.g., the vehicles trajectory, line of apparent travel, destination path, and/or time until arrival at the target illumination zone), and/or other data relevant to the vehicle may be stored in memory of the computing device. Such data may be stored in tables in the memory, such as tag tables and/or prediction tables. Upon predictions being determined or at some point after a white light image capture, the data in each table may be deleted or removed.

Another embodiment of the disclosure is directed to a vehicle license plate reading (LPR) system. The system may include a NIR or IR emitter. The NIR or IR emitter may include an array of NIR or IR LEDs. The system may include an array of RGB or white LEDs and a lens disposed in front of the array of RGB or white LEDs. The lens may be configured to focus the white light produced by one or more LEDs of the array of RGB or white LEDs. The system may include a camera configured to capture NIR or IR images reflected by NIR or IR light and white light images reflected by the white light. The NIR or IR images and white light images may include images of at least a vehicle's license plate.

The system may include a computing device. The computing device may include memory for storing captured NIR or IR images, white light images, and vehicle information capture instructions. The system may include one or more processors. The one or more processors may be configured to execute the vehicle information capture instructions from memory. The executed vehicle information capture instructions may initiate continuous or periodic pulses from the NIR or IR emitter. The one or more processors may be configured, when executing the instructions, to receive captured NIR or IR images from the camera.

In some embodiments, the executed vehicle information capture instructions may determine if two or more contiguous NIR or IR images of the license plate are captured. The executed vehicle information capture instructions may, in response to a determination that two or more contiguous NIR or IR images of the license plate are captured, determine a target illumination zone and a time that the license plate will be in the target illumination zone. The executed vehicle information capture instructions may, in response to a determination that the time that the license plate will be in the target illumination zone has been met, activate one or more LEDs of the array of RGB or white LEDs to produce a targeted pulse of white light directed toward the target illumination zone. The executed vehicle information capture instructions may capture white light images illuminated by the targeted pulse of white light. The executed vehicle information capture instructions may determine a license plate number and at least one additional identifying feature of the license plate and/or the vehicle. In other aspects, the additional identifying feature of the license plate and/or the vehicle may include one or more of a state or country of origin of the license plate, a vehicle's make, model, color, and/or other identifying portions or attributes, including, for way of example and not limitation, bumper stickers, signage or lettering, accessories, decals or other images or customized features, etc . . .

In other aspects the NIR or IR emitter and the array of RGB or white LEDs may be disposed side-by-side in the system. In yet another aspect the NIR or IR emitter may be positioned above or attached to the top of the array of RGB or white LEDs. In yet another aspect the array of RGB or white LEDs may be positioned above or attached to the top of the NIR or IR emitter.

In another aspect, the NIR or IR emitter and array of RGB or white LEDs may be fixedly mounted within the system. In yet another aspect, the NIR or IR emitter and/or the array of RGB or white LEDs may be moveably mounted within the system.

In another aspect, the computing device may determine where the array of RGB or white LEDs is to be pointed based on captured NIR or IR images of the license plate. The computing device may also determine where the NIR or IR emitter is to be pointed based on previously captured NIR or IR images of license plates.

In another aspect, captured NIR or IR images may be removed from memory after determining the target illumination zone and the time. The captured white light images may also be removed from memory after determining a license plate number and state or country of origin of the license plate.

Another embodiment of the disclosure is directed to a white light illumination based license plate reading (LPR) apparatus. The apparatus may include an array of NIR or IR LEDs. The apparatus may include an array of RGB or white LEDs. The apparatus may include a lens disposed in front of the RGB or white LEDs. The lens may focus the white light produced by one or more LEDs of the array of RGB or white LEDs at a target or target illumination zone. The apparatus may include a camera. The camera may include image sensors capable of capturing NIR or IR images and white light images of a license plate and other portions of a vehicle. The NIR or IR images may be captured during illumination by the array of NIR or IR LEDs during a continuous or substantially continuous interval of time or time frame. The white light images may be captured during illumination by the one or more LEDs of the array of RGB or white LEDs during a pulse. The pulse may be determined based on contiguous captured NIR or IR images. The contiguous captured NIR or IR images may include a time and location of the NIR or IR images. Such time and location may be utilized to determine the trajectory of vehicle, a target illumination zone based on the trajectory, and a time that the vehicle will be in the target illumination zone.

The apparatus may include memory to store captured NIR or IR images, white light images, license plate numbers, license plate state or country of origin, vehicle make, vehicle model, and/or vehicle color. In another aspect captured white light images are removed from memory after determining a license plate number and license plate state or country of origin.

Still other aspects and advantages of these embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure herein disclosed, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. These and other features, aspects, and advantages of the disclosure will become better understood with regard to the following descriptions, claims, and accompanying drawings. It is to be noted, however, that the drawings illustrate only several embodiments of the disclosure and, therefore, are not to be considered limiting of the scope of the disclosure. Embodiments incorporating teachings of the present disclosure are shown and described with respect to the drawings herein, in which:

FIG. 1 is a schematic diagram of an illuminator for a license plate reading (LPR) system, according to the present disclosure.

FIG. 2 is a schematic diagram of a white light illuminator for a license plate reading (LPR) system, according to the present disclosure.

FIG. 3A, FIG. 3B, and FIG. 3C are schematic diagrams of various configurations of white light illuminators and near infrared or infrared illuminators for a license plate reading (LPR) system, according to the present disclosure.

FIG. 4 is a schematic diagram of a white light LED array and lens to direct white light, according to the present disclosure.

FIG. 5 is a block diagram illustrating a determination of a time of arrival for a target illumination zone, according to the present disclosure.

FIG. 6 is a block diagram of a LPR, according to the present disclosure.

FIG. 7A and FIG. 7B are flow diagrams of processes as performed by a license plate reading (LPR) system, according to the present disclosure.

The use of the same reference symbols in different drawings indicates similar or identical items.

### DETAILED DESCRIPTION

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings. So that the manner in which the features and advantages of the embodiments of the systems and methods disclosed herein, as well as others that will become apparent, may be understood in more detail, a more particular description of embodiments of systems and methods briefly summarized above may be had by reference to the following detailed description of embodiments thereof, in which one or more are further illustrated in the appended drawings, which form a part of this specification. It is to be noted, however, that the drawings illustrate only various embodiments of the systems and methods disclosed herein and are therefore not to be considered limiting of the scope of the systems and methods disclosed herein as it may include other effective embodiments as well.

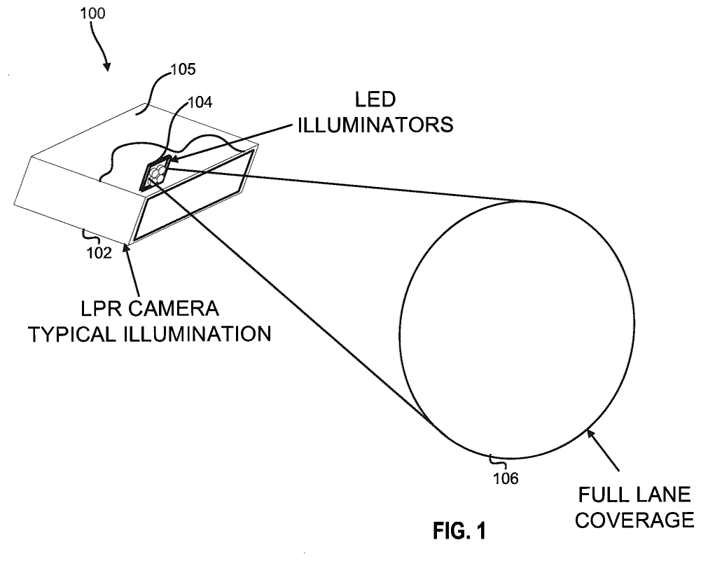

FIG. 1 is a schematic diagram of an illuminator of for use in an LPR system, according to the present disclosure. Such a LPR system 100 may include a near infrared (NIR) or infrared (IR) illuminator 103. The NIR or IR illuminator 103 may be included in a LPR system's housing 102. The housing 102 may be separate from or integrated into a camera or image capture device housing of the LPR system 100. The housing 102 may include other components, such as a computing device or controller, image sensors, and/or other illuminators, as described herein. As the camera or image sensors capture an image, e.g., a NIR or IR image, a NIR or IR LED array 104 or NIR or IR emitter of the illuminator 103, shown disposed within housing 102, may illuminate a target. The camera or image sensors may be configured to capture the NIR or IR images visible by the NIR or IR light striking and/or illuminating the target vehicle. FIG. 1 further illustrates a top portion 105 of the housing 102 with a cut-away to show the NIR or IR LED array 104 disposed within the housing 102. In such embodiments, the NIR or IR LED array 104 may include retention features corresponding to retention features within the housing 102.

The LPR system 100 may provide full lane coverage 106 of any particular roadway, e.g., two-lane road, three-lane road, four-lane road, etc. and/or a road with unidirectional lanes or bidirectional side-by-side lanes. Bidirectional side-by-side lanes may refer to, for example, two sets of lanes, where one set of lanes includes traffic moving in one direction, while the other set of lanes includes traffic moving in an opposite direction. Such LPR systems 100 may continuously or periodically, e.g., every 16 milliseconds, every 32 milliseconds, every 64 milliseconds, etc., illuminate a target for image capture. A target may refer to a vehicle. In particular, a target may refer to a vehicle's license plate or other portion of the vehicle indicating information, e.g., make and/or model. A vehicle may refer to a motorist vehicle, such as a car, truck, eighteen wheelers, other heavy vehicles, motorcycles, and/or any other vehicle including a license plate. Due to the use of NIR or IR light, which is barely visible or not visible at all to the human eye, such frequent image captures may not distract a driver or cause unsafe driving conditions. However, such a LPR system 100 cannot distinguish between color and merely captures a license plate number. Further, if a surface of a license plate is covered with a material or altered to eliminate or reduce reflectivity or if a custom or non-United States based license plate is used, then the LPR system 100 may not capture the license plate number or any other information.

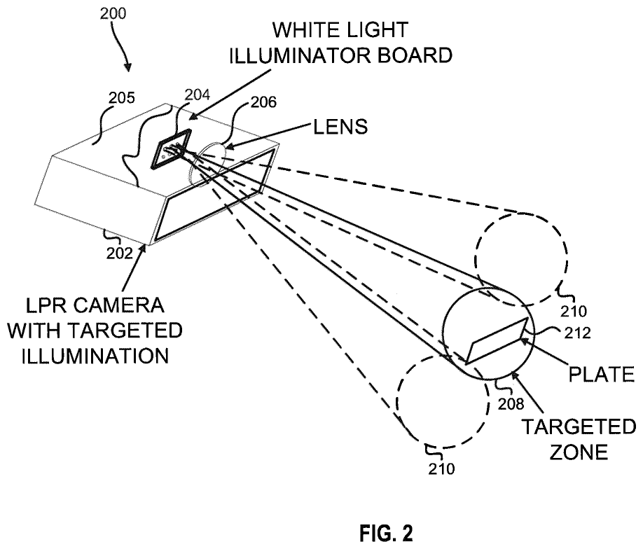

The use of a NIR or IR LED array 104 in conjunction with a white light illuminator 200, such as a white light LED array 204, provides the LPR system 100 or LPR camera with higher accuracy in image captures, and the further potential to capture additional information in an image, while ensuring that drivers remain safe and unaffected from frequent white light strobes or pulses. The white light LED Array 204, as illustrated in FIG. 2, may also be included in a housing 202. The LPR system 100 may include a camera or image sensors. The LPR system 100 may also include the NIR or IR LED array 104 or NIR or IR emitter. The LPR camera or LPR system may include the NIR or IR LED array 104 board and the white light LED array 204 board in various configurations or in separate housings. The white light LED array 204 may be attached to or connected to the LPR camera or LPR system's housing 202 or may be integrated into the LPR camera or LPR system's housing 202. In another embodiment, the white light LED array 204 may be an optional and/or add-on accessory included in a separate housing, to enable the use of white light image capture in conjunction with an LPR system 100 according to the principles of the present disclosure. Further, such a separate housing may include attachment or tool-less attachment features to allow for quick and simple attachment of the white light LED array 204 to corresponding retention or attachment features of an image capture device, LPR camera, or LPR system.

The housing 202 of the LPR system 100 may include a white light LED array 204. The white light LED array 204 may be composed of white light LEDs or a combination of red, green, blue (RGB) LEDs. The white light LED array 204 may be assembled and powered to offer just enough, e.g., of a sufficient intensity for a sufficient time, targeted white light for an image sensor or camera to capture a color picture or image of a license plate 212 at a certain distance. FIG. 2 further illustrates a top portion 205 of the housing 202 with a cut-away to show the white light LED array 204 disposed within the housing 202. In such embodiments, the white light LED array 204 may include retention features corresponding to retention features within the housing 202.

The LPR system 100 may include an on-board power source or may connect to a power source. In such examples, the housing 202 may include power connectors. On-board power sources may include batteries, capacitors, or other power storage devices. A cable, pins, or a socket may be disposed on the outside of the housing 202 to connect to a power source.

The white light LED array 204 of the white light illuminator 200 may include a circuit board(s) with pins or a socket including tracing or traces to each LED of the white light LED array 204. The pins or socket may correspond to a socket or pins, respectively, located on the LPR system, LPR camera, image capture device, and/or housing 202. The pins or sockets may connect to and allow for transfer of power to the white light LED array 204, in addition to other data signals, e.g., signals to indicate when to illuminate or activate which LEDs of the white light LED array 204. In another embodiment, the white light LED array 204 may include a controller or control board including one or more processors. As signals are received from a camera, image capture device, and/or computing device, the controller or control board may send a signal to a specified LED or LEDs. The signal may cause the specified LED or LEDs to illuminate or activate for a specified period of time.

The LPR system 100 may include a lens 206. The lens 206 may be disposed or positioned in front of the white light LED array 204. As one or more of the LEDs of the white light LED array 204 are illuminated or activated, the lens 206 may focus the light from the illuminated LEDs to a target. In such examples, the lens 206 may be a convex or Fresnel lens, although other types of lenses also can be used. The lens 206 may be comprised of glass, plastic, or any other suitable material. The lens 206 may be positioned or disposed before an aperture or opening of the housing 202. In another embodiment, the lens 206 may be disposed in the aperture or opening. In yet another embodiment, the lens 206 may be positioned over the outside housing 202 in front of the aperture or opening of the housing 202. In any embodiment, the housing 202 may include features to retain the lens 206.

As noted, as one or more of the LEDs of the white light LED array 204 are illuminated or activated, the lens 206 may focus the light from the illuminated LEDs to a target, target illumination zone, or white light target zone. A computing device, camera, image capture device, controller, or other suitable device may also determine a number of target illumination zones (see 208 and 210). Each target illumination zone may correspond to an LED or combination of LEDs. Such a determination may be based on a focal point of the lens 206. The computing device, camera, image capture device, controller, or other suitable device may determine a targeted zone 208 or white light target zone based on NIR or IR images of a license plate 212 captured over a period of time by the camera or image sensors while illuminating the license plate with the NIR or IR illuminator 103. Factors included in determining a targeted zone 208 may also include the speed a vehicle is traveling, a particular lane that the vehicle is traveling in, the position of the vehicle at a first time and second time, other factors, and/or some combination thereof. Depending on such factors, particular LEDs of the white light LED array 204 may be illuminated at determined periods of time to target specific zones or areas, e.g., targeted zone 208, zones 210, and/or other zones.

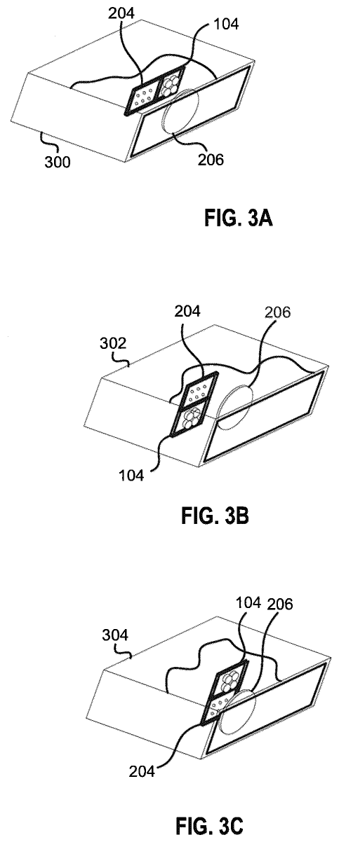

As noted, a white light illuminator 200 may be attached to an image capture device, camera, the NIR or IR illuminator, or other device in a variety of configurations, as illustrated in FIG. 3A, FIG. 3B, and FIG. 3C. In FIG. 3A, the white light LED array 204 may be connected adjacent to or in a side-by-side configuration with the NIR or IR LED array 104 (see 300). In FIG. 3B, the bottom portion or edge of the board of the white light LED array 204 may be connected, attached, or connected to the top portion or edge of the NIR or IR LED array 104 (see 302). In FIG. 3C, the top portion or edge of the board of white light LED array 204 may be connected, attached, or connected to the bottom portion or edge of the NIR or IR LED array 104 (see 304). In such embodiments, each board may include retention features, e.g., slides, friction fit features, snaps, locks, and/or latches, corresponding to other retention features of other boards, allowing each board to connect to another board. Various other configurations may exist including the white light LED array 204, the lens, the NIR or IR LED array 104, and/or some combination thereof integrated into an image capture device or camera.

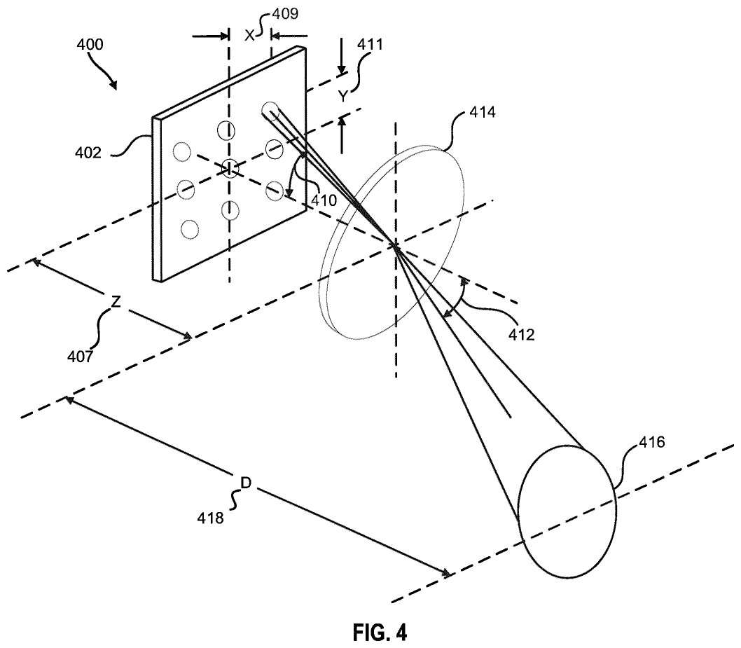

FIG. 4 is a schematic diagram of a white light LED array and lens to direct white light, according to the present disclosure. The white light LED array 402 may include nine LEDs, less than nine LEDs, or more than nine LEDs. The white light LED array 402 may include RGB or white light LEDs. The white light LED array 402 may be powered off during the periods of time between white light pulses or strobes. Each of the LEDs of the white light LED array 402 may be positioned at distances X 409 and Y 411 in relation to a center line of the lens 414. Further, the white light LED array 402 may be set back at a predetermined distance Z 407. Such a predetermination may be calculated or determined to result in the desired focused illumination at focal distance D 418 such that the target location, zone, or coordinates 416 is illuminated. Such a focused illumination may allow for a camera or image capture device to capture a white light image of anything in the target location, zone, or coordinates 416, e.g., a vehicle's license plate, make (indicated by, for example, a decal), model (indicated by, for example, another decal), color, or other unique characteristics of the vehicle.

Angle A 410 and resultant angle B 412 may be equal. The camera or image capture device focal distance D 418, along with angle A 410 and angle B 412, may be utilized to calculate or determine where each LED, when illuminated, will shine. Such calculations or determinations may be performed for each of the LED's and/or combination of LEDs in the white light LED array 402 resulting in separate target locations, zones, or coordinates for each LED and/or combinations of LEDs. The LPR system or computing device associated with the white light illuminator 400 may store each of these target locations, zones, or coordinates. The stored target locations, zones, or coordinates may be utilized as target coordinates to be used when a location of a potential target is determined. For example, when a top right LED, as illustrated in FIG. 4, is illuminated or activated, the resulting white light may shine to the target location, zone, or coordinates 416. Lighting a different LED may result in another area or target being illuminated.

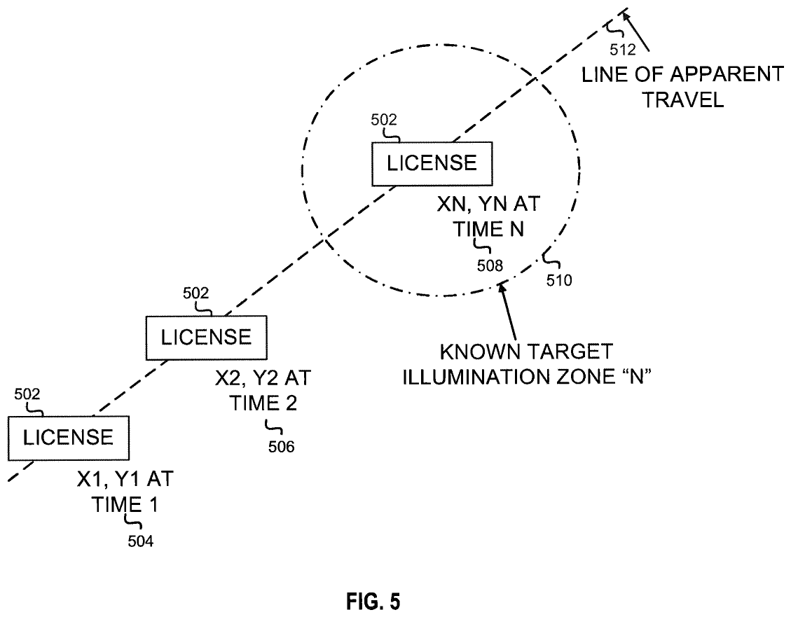

Such target locations, zones, or coordinates may be plotted on a map or area, e.g., by a computing device or the LPR system, where the LPR system may be located or deployed. In other words, the limits and range of a NIR or IR illuminator may be mapped for a road, e.g., as x and y coordinates, and, in relation to the mapped road, the target locations, zones or coordinates may be mapped as an area of the road, e.g., also as x and y coordinates. Such target locations, zones or coordinates may be referred to as known target illumination zones (see 510 in FIG. 5).

FIG. 5 is a block diagram illustrating a determined target illumination zone 510, according to the present disclosure. As used herein, a “computing device” may refer to an electronic device including or connected to one or more processors and non-transitory machine-readable storage medium, e.g., including, but not limited to, a controller, a desktop computer, a microcontroller connected to memory, a server, an edge server, a processor and memory of a camera or image capture device, or other devices, as will be understood by those skilled in the art. As used herein, a “non-transitory machine-readable storage medium” or “memory” may be any electronic, magnetic, optical, or other physical storage apparatus to contain or store information such as executable instructions, data, and the like. For example, any machine-readable storage medium described herein may be any of random access memory (RAM), volatile memory, non-volatile memory, flash memory, a storage drive (e.g., hard drive), a solid state drive, any type of storage disc, and the like, or a combination thereof. As noted, the memory may store or include instructions executable by the processor. As used herein, a “processor” may include, for example one processor or multiple processors included in a single device or distributed across multiple computing devices. The processor may be at least one of a central processing unit (CPU), a semiconductor-based microprocessor, a graphics processing unit (GPU), a field-programmable gate array (FPGA) to retrieve and execute instructions, a real time processor (RTP), application specific integrated circuit (ASIC), other electronic circuitry suitable for the retrieval and execution instructions stored on a machine-readable storage medium, or a combination thereof.

As a vehicle travels, a LPR system or computing device may capture images of the license plate 502 of the vehicle. Each image may include coordinates or a location of the vehicle at a specified time (see 504, 506, and 508). Using at least two coordinates or locations, e.g., first location 504 and second location 506, from two captured NIR or IR images, the LPR system may calculate or determine a slope and intercept of the vehicle, a line of apparent travel 512, or a destination path. Such a determination may be made by first calculating the rise and run of the coordinates of the vehicle. The LPR system may then determine the slope, e.g., m, for the slope-intercept form, e.g., y=mx+b, using the rise divided by the run. The LPR system may then determine the intercept of the slope-intercept form, based on any of the coordinates of the at least two images. The LPR system may then predict where the vehicle will be at a certain point in time. Other calculations, determinations, or methods may be utilized to determine or predict such a path.

As noted above, the LPR system may determine specific zones for each LED and/or combinations of LEDs of a white light LED array. Utilizing the coordinates of each specific zone and the predicted line of apparent travel 512 or destination path, the LPR system may determine which specific zone, e.g., a known target illumination zone 510, the vehicle may travel through at a future point in time, e.g., location N, as denoted at 508. Stated another way, the LPR system may determine, based on the coordinates of the multiple known illumination zones and the slope-intercept of the vehicle, line of apparent travel 512, or destination path of the vehicle, the best known target illumination zone to be utilized to capture an image of the license plate or other portion of the vehicle.

Once the known target illumination zone 510 to be utilized is determined, the LPR system may determine the distance from the last location, e.g., the second location 506, to the known target illumination zone 510. Such a distance may be calculated using, for example, (Xn−X2)²+(Yn−Y2)². Other calculations, determinations, or methods may be utilized to determine such a distance.

Once the known target illumination zone 510 to be utilized is determined and a distance from the last location to the known target illumination zone 510 is determined, the LPR system may determine the length of time until the vehicle reaches the known target illumination zone 510. As noted, each captured image may include a time when the image was captured, e.g., T1 for the first location 504 and T2 for the second location 506. To determine such a length of time, the LPR system may first calculate the velocity of the vehicle using the formula (\sqrt{(X2−X1)²+(Y2−Y1)²})/(T2−T1).

Using the determined distance to the known target illumination zone 510 and the velocity, the LPR system may determine an arrival time for the vehicle to arrive in the known target illumination zone 510. Such a determination may be stored in memory of the LPR system or a prediction table of the LPR system. Based on the arrival time, the LPR system may send or transmit a signal to the white light illuminator, at the time of arrival. The signal may indicate which LED, of an array of LEDs of the white light illuminator, to illuminate. The signal may further indicate how long to illuminate the LED.

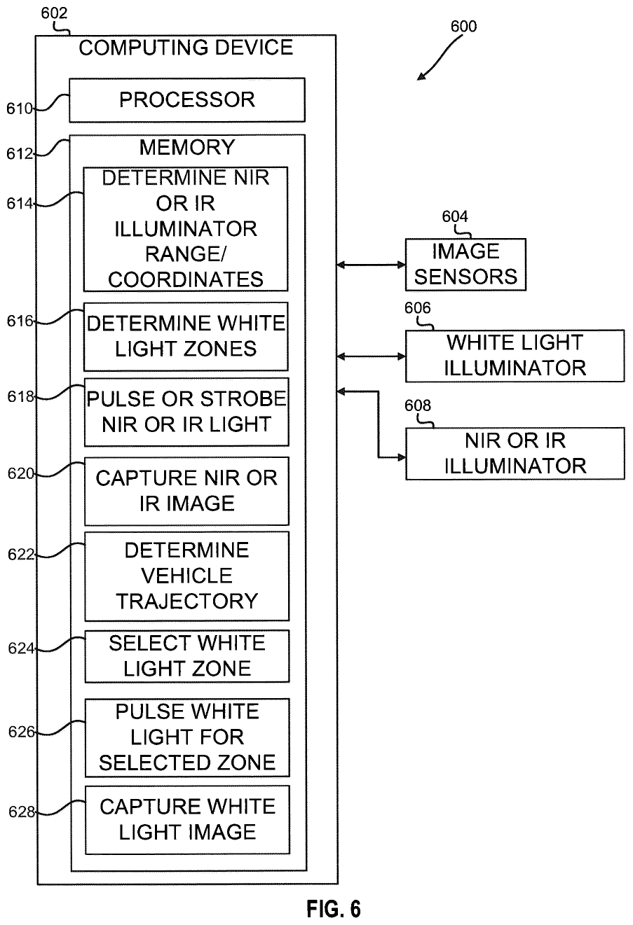

FIG. 6 is a block diagram of a license plate reader, according to the present disclosure. The license plate reader (LPR) 600 may include one or more processors 610. The one or more processors 610 may be connected to memory 612. The computing device 602 may be connected to or in signal communication with the image sensors 604 (e.g., of a camera or image capture device), the white light illuminator 606, and the NIR or IR illuminator 608. The memory 612 may include vehicle information capture instructions. The vehicle information capture instructions may be executed by the one or more processors 610.

The memory 612 may include instructions 614 to determine the NIR or IR illuminator 608 range, coordinates, limits, or lane coverage. The instructions 614, when executed, may determine the limits of the NIR or IR illuminator 608. The instructions 614 may also determine the coordinates of such limits. Such coordinates may be utilized to determine the location of vehicles or be associated with the location of vehicles. For example, an image capture of a vehicle at a certain distance may be associated with a x and y number or coordinates. As the vehicle moves further down a destination path, x and y may increase or change in some way, based on the mapping discussed herein. Such coordinates or associations may be stored in a table. The table may be stored in memory 612.

The memory 612 may include instructions 616 to determine target illumination zones. The instructions 616 may be executed or performed for each LED and/or combination of LEDs of the white light illuminator 606. Similar to the coordinates determined for the NIR or IR illuminator 608, each zone may be associated with x and y coordinates. The coordinates for each the target illumination zone may be stored in a table. The table may be stored in memory 612. The coordinates may be determined based on the location of the LED in the white light illuminator 606, the distance of the LEDs from a lens of the white light illuminator 606, the intensity of the light from the LED, the focal point of lens, and/or some combination thereof.

In an embodiment, the memory 612 may include instructions to continuously strobe NIR or IR light from the NIR or IR illuminator 608 at a particular or specified interval. In another embodiment, the memory 612 may include instructions 618 to determine how often to strobe, pulse, or activate NIR or IR light from the NIR or IR illuminator 608. In an embodiment, the instructions 618 may vary the amount of pulses or a strobe rate based on different conditions. For example, if no vehicle is detected, the instructions 618 may pulse or strobe the NIR or IR light less frequently, e.g., every 15 seconds, 30 seconds, or 1 minute, thus capturing images at a slower rate. Once a vehicle is detected, the NIR or IR light may be pulsed more frequently or the strobe rate increased, e.g., one or more pulses per second, thus increasing the amount of images captured. As the instructions 618 are executed, signals may be sent or transmitted to the NIR or IR illuminator 608 indicating illumination of the NIR or IR lights or LEDs within the NIR or IR illuminator 608. In another embodiment, the NIR or IR illuminator 608 may be constantly or continuously illuminated.

The memory 612 may include instructions 620 to capture a NIR or IR image. The instructions 620 may be executed in conjunction with instructions 618. In other words, as NIR or IR lights or LEDs are illuminated, a signal may be sent or transmitted to the image sensors 604 to capture a NIR or IR image. If the NIR or IR light is continuously illuminated, the instructions 620 may indicate when to actually capture an image.

The memory 612 may include instructions 622 to determine a vehicle's trajectory. A vehicle's trajectory may include the path or line of apparent travel, as well as a velocity of the vehicle. The instructions 622 may first determine whether more than one image of the vehicle is captured. If more than one image is captured, the instructions 622 may continue on with the determination, otherwise the instructions 622 may request further images. The instructions 622 may determine the coordinates of each image and, using the coordinates, may determine the path or line of apparent travel. The instructions 622 may determine which of the target illumination zones are along the path or line of apparent travel. The instructions 622 may select or indicate a selection of the target illumination zone along the path or line of apparent travel, thereby defining a selected target illumination zone or white light target zone. The instructions 622 may then determine the velocity of the vehicle based on the time associate with each image, e.g., a time stamp or other indicator indicating time. Based on the velocity and remaining distance to the selected target illumination zone, the instructions 622 may determine a time remaining or a time to pulse white light and capture a white light image. Such determinations may be stored in a table in memory 612. The table may be a prediction table, while actual images and other data may be stored in a tag table.

The memory 612 may include instructions 624 to select a target illumination zone. In an embodiment, instructions 624 may be included in instructions 622. In another embodiment, instructions 624 may select a target illumination zone based on the determinations or calculations performed in instructions 622. In yet another embodiment, instructions 624 may transmit a signal to the white light illuminator 606 indicating which LED is to be illuminated for an upcoming image capture.

The memory 612 may include instructions 626 to pulse a white light for the selected target illumination zone. The instructions 626 may be executed upon reaching the end of the time remaining or reaching the time to pulse. A clock or counter may indicate when such a time is met or reached. Upon reaching the time remaining or meeting the time to pulse, the instructions 626 may send or transmit a signal to the white light illuminator 606 to pulse white light for the selected target illumination zone. The memory 612 may include instructions 628 to capture the white light image. Such instructions 628 may be executed in conjunction with instructions 626.

The computing device may include further instructions to determine a license plate number, state or country of origin of the license plate, vehicle make, vehicle model, vehicle color, and/or other characteristics of the vehicle based on the captured white light image. Such information or data may be stored in the memory 612 of the computing device or sent or transmitted to external storage, a database, and/or another computing device. Further, such information may be displayed to or on a user interface, along with other information from memory 612, external storage, and/or a database. Other information may include a vehicle history, notifications associated with the vehicle, vehicle records, warnings or alerts associated with the vehicle, and/or warnings or alerts associated with a vehicle of similar description.

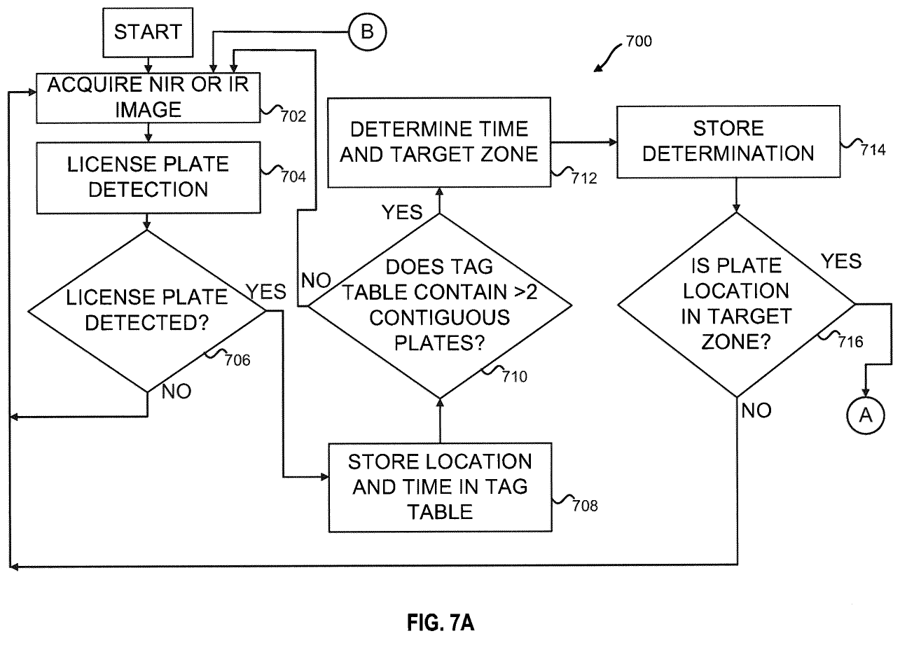

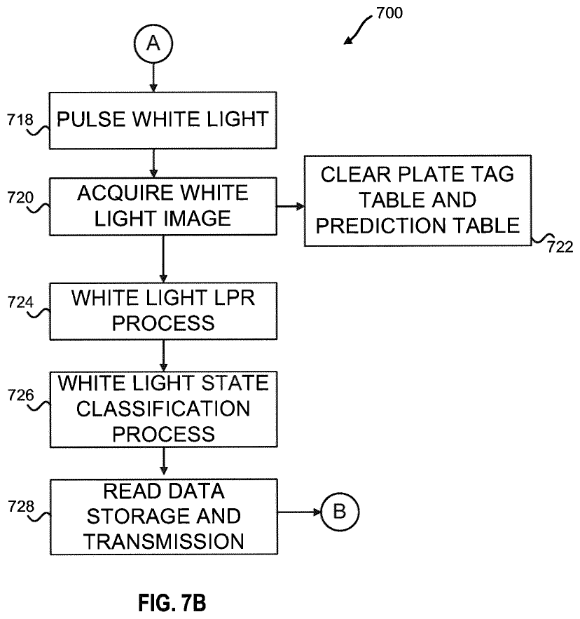

FIGS. 7A and 7B are flow diagrams, implemented in a computing device, of processes as performed by a license plate reader (LPR) system, according to the present disclosure. While method 700 is detailed with reference to the LPR 600 of FIG. 6, other components of FIGS. 1 through 4 may be utilized in such a method. Unless otherwise specified, the actions of method 700 may be completed within the LPR 600. Specifically, method 700 may be included in one or more programs, protocols, or instructions loaded into memory 612 of a computing device 602 of the LPR 600. The order in which the operations are described is not intended to be construed as a limitation, and any number of the described blocks may be combined in any order and/or in parallel to implement the methods.

At block 702, the computing device 602 may acquire one or more NIR images or IR images. The computing device 602 may utilize the image sensors 604 or a camera to obtain such images. Further, during image capture by either the image sensors 604 or camera, the computing device 602 may send or transmit a signal to the NIR or IR illuminator 608 to pulse or strobe at the time an image capture is desired.

At block 704, once the computing device 602 has obtained, acquired, or received an NIR image or IR image, the computing device 602 may determine or detect a license plate in the image. Such a detection may be determined by instructions stored in the memory 612 of the computing device 602. Such instructions may include a machine learning model or other image recognition program capable of determining whether an image has a license plate.

At block 706, the computing device 602 may determine whether a license plate has been detected. If no license plate has been detected, then the computing device 602 may attempt to obtain more NIR images or IR images or may check or determine whether an entity, vehicle, or license plate is included in a prediction or tag table. If a license plate is detected, at block 708, the computing device 602 may store the location of the license plate and the time the NIR image or IR image is captured in a tag table. A tag table may be a list or table of different values stored in a memory, e.g., memory 612 or a database connected to the computing device 602.

In some embodiments, the computing device 602 further may determine whether an entity, vehicle, or license plate from an NIR or IR image is included in a prediction or tag table. For example, the computing device can check to see if a detected license plate is present in a prediction or tag table, e.g. as indicated at 710. If a license plate is not detected, the computing device can determine if an entity, vehicle, or other identifier captured by the NIR or IR image is included in a prediction or tag table, from which a correlation between such image and a vehicle potentially can be made; and If the entity, vehicle, or license plate is in the prediction table, the computing device 602 may determine whether the license plate is in the target illumination zone. If not, the entity, vehicle, or other identifier captured by the NIR or IR image is not included in the prediction or tag table, the computing device 602 may attempt to acquire additional NIR or IR images.

At block 710, the computing device 602 may determine whether the tag table contains more than two contiguous license plates. In other words, the computing device 602 may determine whether the tag table includes at least two images of the same license plate or vehicle.

At block 712, if the tag table includes two or more contiguous license plates, the computing device 602 may determine a target illumination zone and when the license plate may be in the target illumination zone. Such a determination may be performed via a slope intercept form calculation and a calculation of vehicle velocity, based on the location of the vehicle at a time when the images are captured. As such, the computing device 602 may determine when to capture a white light image utilizing the white light illuminator 606. At block 714, the computing device may store such determinations, e.g., the target illumination zone and when the license plate may be in the target illumination zone.

At block 716, the computing device 602 may check or determine whether the license plate is in the target illumination zone at the determined time. If the license plate is not in the target illumination zone, the computing device 602 may acquire, obtain, or receive further NIR images or IR images. In another example, the computing device may utilize the time of arrival of the vehicle in the target illumination zone. Once the time of arrival is reached, the computing device 602 may capture the white light image.

At block 718, the computing device 602 may send or transmit a signal to the white light illuminator 606 indicating that the white light illuminator should pulse one or more particular LEDs of an LED array. At block 720, the computing device 602 may acquire, obtain, or receive the white light image. Once the white light image is determined, the NIR images, IR images, and/or other data relevant to the license plate other than the actual white light image, at block 722, may be cleared from the tag table and prediction table.

At block 724, the computing device 602 may perform the white light LPR process. Such a process may perform image recognition to determine a license plate. The license plate may be compared to relevant databases to determine whether the license plate is associated with criminal activity. Such determinations may include instructions to re-create the numbers or letters of a license plate automatically. The white light LPR process may include other steps.

At block 726, the computing device 602 may determine the state or a country that a license plate is from or associated with. The computing device 602 may determine the state based on instructions similar to that used in block 724. Thereafter, once the state, country, license plate number, the make of the vehicle, the model of the vehicle, the color of the vehicle, and/or some combination thereof is determined, the computing device 602 may clear any remaining data from the tag table and prediction data. At block 728, the computing device 602 may store or transfer the determined data, e.g., in memory 612, external storage, or an external database.

The foregoing description generally illustrates and describes various embodiments of the present disclosure. It will, however, be understood by those skilled in the art that various changes and modifications can be made to the above-discussed construction of the present disclosure without departing from the spirit and scope of the disclosure as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present disclosure. Accordingly, various features and characteristics of the present disclosure as discussed herein may be selectively interchanged and applied to other illustrated and non-illustrated embodiments of the disclosure, and numerous variations, modifications, and additions further can be made thereto without departing from the spirit and scope of the present invention as set forth in the appended claims.

1. (canceled)

2. A system, comprising:
a NIR or IR emitter;
a white light illuminator;
a camera or image capture device configured to capture NIR or IR images and white light images of vehicle license plates; and
at least one computing device including one or more processors configured to execute information capture instructions to:
receive captured NIR or IR images of the vehicle license plates from the camera or image capture device,
based on one or more of the captured NIR or IR images, determine a projected trajectory of a target vehicle license plate;
based on the projected trajectory, determine a target illumination zone through which the target license plate is projected to pass; and
generate at least one targeted pulse of white light from the white light illuminator, the at least one targeted pulse of white light being directed toward the target illumination zone at an estimated time when the target vehicle license plate is expected to arrive at or be within the target illumination zone; and
receive one or more white light images, including at least one white light image of the target license plate, captured by the camera or image capture device and determine a license plate number of the target license plate.

3. The system of claim 2, wherein the at least one computing device is further configured to generate to the at least one targeted pulse of white light for a time and at an intensity sufficient to capture the one or more white light images of the target license plate within the target illumination zone.

4. The system of claim 2, wherein the NIR or IR emitter and the white light illuminator are located together within a housing with the camera or image capture device.

5. The system of claim 2, wherein the white light illuminator comprises an array of RGB or white LEDs and a lens disposed in front of the array of RGB or white LEDs connected to the camera or image capture device.

6. The system of claim 2, wherein the one or more white light images captured by the camera or image capture device include one or more images of a vehicle with which the target license plate is associated; and wherein the at least one computing device is further configured to determine at least one additional identifying feature of the target license plate or the vehicle with which the target license plate is associated.

7. The system of claim 6, wherein the at least one additional identifying feature includes information indicating a state or country of origin, vehicle make, vehicle model, a color of the vehicle or target license plate, or other unique characteristic, or a combination thereof.

8. A license plate reading system comprising:
a NIR or IR LED emitter;
a white light illuminator;
a camera or image capture device configured to capture NIR or IR images and capture one or more white light images, including capturing one or more white images of at least a license plate of at least one target vehicle; and
at least one computing device including:
one or more processors configured to execute a series of vehicle information capture instructions to:
continuously or periodically illuminate NIR or IR LEDs of the NIR or IR emitter;
receive a series of captured NIR or IR images from the camera or image capture device and determine a target illumination zone within which the license plate of the vehicle projected to pass based on a projected trajectory of the vehicle and an estimated arrival time when the vehicle is projected to be within the target illumination zone;
upon the estimated arrival time being met or expiring, directing at least one pulse of white light toward the target illumination zone to illuminate the license plate of the vehicle within the target illumination zone, the at least one pulse of white light having an intensity sufficient to enable an light image of the license plate of the vehicle to be captured;
receive one or more white light images, including at least one white light image of the license plate of the vehicle, captured by the camera or image capture device; and
determine a license plate number of the license plate of the vehicle based on the captured one or more white light images.

9. The license plate reading system of claim 8, wherein the at least one computing device is further configured to determine at least one additional identifying feature of one or more of the license plate or the vehicle based on the captured one or more white light images.

10. The license plate reading system of claim 9, wherein the at least one additional identifying feature includes information indicating a state or country of origin, vehicle make, vehicle model, a color of the vehicle or target license plate, or other unique characteristic, or a combination thereof.

11. The license plate reading system of claim 8, wherein the at least one computing device further includes a memory for storing captured NIR or IR images, white light images, and the vehicle information capture instructions.

12. The license plate reading system of claim 11, wherein at least the captured white light images are removed from the memory after determining a license plate number of the license plate.

13. The license plate reading system of claim 8, the white light illuminator comprises an array of RGB or white light LEDs configured to connect to the camera or image capture device.

14. The license plate reading system of claim 8, wherein the camera or image capture device includes one or more image sensors configured to capture NIR or IR images and white light images.

15. A computer implemented method wherein at least one computing device is configured to execute vehicle capture instructions for capturing vehicle information from a plurality of vehicles, comprising:
continuously or periodically illuminating a selected area or zone with NIR or IR light;
receiving a plurality of captured NIR or IR images of one or more license plates of One or more vehicles;
based on the captured NIR or IR images, determining a target illumination zone through which a target vehicle is expected to travel and an estimated arrival time when the target vehicle is projected to be within the target illumination zone;
once the estimated arrival time when the vehicle is projected to be within the target illumination zone has been met or expires, directing at least one pulse of white light toward the target illumination zone sufficient to illuminate a license plate of the target vehicle for capture of one or more white light images of the license plate within the target illumination zone;
capturing the one or more white light images of the license plate; and
determining a license plate number of the license plate.

16. The computer implemented method of claim 15, further comprising determining whether the vehicle is in the target illumination zone prior to directing the pulse of white light toward the target illumination zone.

17. The computer implemented method of claim 15, wherein the target illumination zone is defined by a portion of a roadway.

18. The computer implemented method of claim 17, wherein a determination of the portion of the roadway along which the target illumination zone is defined is based on a projected trajectory of the vehicle; wherein the projected trajectory of the vehicle is determined based on a slope and intercept calculated based on a location of the vehicle at a first time and a location of the vehicle at a second time.

19. The computer implemented method of claim 15, the selected area or zone comprises a roadway; and wherein a plurality of target illumination zones are determined for different portions of the roadway based on the captured NIR or IR images.

20. The computer implemented method of claim 15, wherein the at least one pulse of white light is directed at the target illumination zone at a time interval, intensity, focus, distance, or combinations thereof, such that a driver of the vehicle will not see the pulse of white light, while being sufficient to enable capture of the one or more white light images.

21. The computer implemented method of claim 15, further comprising at least temporarily storing the captured NIR or IR images and white light images in a memory connected to the at least one computing device.
